(19) United States
(12) Patent Application Publication
(10) Pub. No.: US 2023/0162493 A1
(43) Pub. Date: May 25, 2023

(54) METHOD FOR THE AUTOMATIC DETECTION OF AORTIC DISEASE AND AUTOMATIC GENERATION OF AN AORTIC VOLUME

(71) Applicant: Riverain Technologies LLC, Miamisburg, OH (US)

(72) Inventors: Steve W. WORRELL, Springboro, OH (US); Xiaotian WU, Pittsburgh, PA (US); Garrett REGAN, Wilmington, OH (US); Jason F. KNAPP, Miamisburg, OH (US); Ofer PINHASI, Beachwood, OH (US); Terry DOLWICK, Springfield, OH (US); Jason MONNIN, Dayton, OH (US)

(21) Appl. No.: 17/992,307

(22) Filed: Nov. 22, 2022

Related U.S. Application Data
(60) Provisional application No. 63/283,062, filed on Nov. 24, 2021.

(51) Int. Cl. G06V 10/82; G06T 7/00

(52) U.S. Cl. CPC G06V 10/82; G06T 7/0012; G06T 2207/30048; G06V 2201/031

(57) ABSTRACT

Automated techniques may be used to process three-dimensional image sets obtained via computer tomography (CT), magnetic resonance imaging (MRI), and other techniques. Image data representing an anatomical feature (e.g., an aorta) may be automatically segmented to obtain mask data for the anatomical feature. The mask data may undergo automated centerline regression to obtain centerline data for the anatomical feature. Automated curved planar reformatting, using the centerline data, may be applied to the original image data and/or the mask data. The curved planar reformation results may be subjected to automated segmentation. The resulting image data set may be used for such purposes as visualization, disease detection, measurement of feature, and/or tracking the anatomical feature over time.

### FIELD OF ENDEAVOR

Aspects of the present disclosure may pertain to processing of radiological images of the aorta or other anatomical structures.

### BACKGROUND

Patients with aortic diseases (e.g., aortic dissection, aneurysm, etc.) are often asymptomatic and may have pathologies that are difficult to detect especially in the early stages. Once they become symptomatic, they may often require immediate and significant intervention and have high associated mortality rates. Imaging modalities used for screening such as ultrasound (US), angiography, computed tomography (CT), positron emission tomography (PET), and magnetic resonance imaging (MRI) need careful expert evaluation and operation, especially in asymptomatic patients, where the imaging was most likely performed for purposes of screening for some other condition.

Advanced image segmentation and visualization techniques (e.g., multi-planar and curved-planar reformats) exist and can aid with quicker diagnosis and more precise measurements to catch difficult-to-find pathology. However, current state-of-the-art systems often require operation by technicians and radiologists to generate these segmentations or reformats in a manual or semi-automatic manner (i.e., the software user will need to define the contours or seed points for segmentation, or the angles, points, lines, and planes to perform the reformats). Though these advanced visualizations may be beneficial, the overhead cost associated with the manual processing of each case may be a significant deterrent, resulting in the loss of utilization. Furthermore, in the presence of disease, segmentation and/or reformation may require significant manual intervention to provide the visualization desired by the radiologists.

Existing technologies based on conventional image processing and traditional computer vision are too rigid to be useful in automating difficult cases; modern methods such as deep learning are capable of such a task but require large quantities of carefully curated data—data that may be extremely difficult to acquire. Therefore, further techniques for processing aortic images may be desirable.

### SUMMARY

Aspects of the present disclosure may pertain to a methodology to address the above-mentioned challenges. Aspects may pertain to a design for the fully automatic analysis of the aorta within computed tomography (CT) scans. The techniques may include methods for automated segmentation, automated curved planar reformatting, and automated disease detection, which may employ simulation of disease and deep learning. These methods may synergize to allow for the detection, measurement, tracking, and advanced visualization of aortic disease cases, which can facilitate triage, enhance clinical diagnosis and monitoring accuracy and precision, and thus, reduce radiologist burnout and improve patient outcomes.

While the discussion below focuses on the aorta, the techniques according to aspects of the present disclosure may be similarly applicable to other anatomical structures, examples of which are discussed below.

### BRIEF DESCRIPTION OF THE DRAWINGS

Various aspects of the present disclosure will now be discussed in detail in conjunction with the accompanying drawings, in which:

FIG. 1 depicts a framework overview according to various aspects of the present disclosure;

FIG. 2 depicts an example of model training according to aspects of the present disclosure;

FIG. 3 depicts an example of a portion of the framework shown in FIG. 1, according to aspects of the present disclosure; and

FIG. 4 depicts an example of an apparatus in which aspects of the present disclosure may be implemented.

### DETAILED DESCRIPTION OF ASPECTS OF THE DISCLOSURE

For the purpose of providing context, the following terminology focuses on the clinical and/or medical domain in the context of aspects of the present disclosure.

Simulation may refer to the generation of medical imagery exemplars that embody the space of possibility in the context of aortic anatomy and pathology.

Auto semantic segmentation (or “auto segmentation,” as it will be referred to hereinafter) is the process of assigning pixels or voxels within a stack of medical images to a particular class.

A 3D mask is a binary representation of the voxels in a stack of medical images associated with a particular class of interest.

A centerline is a series of center points obtained at each cross section of a tubular structure like the aorta. A centerline for the aorta traverses through the center of the aortic lumen without being biased by disease or abnormality.

Image reformation is a representation of a series or stack of medical images in a different perspective, which may facilitate enhanced visualization. For curved planar reformation (CPR), voxels in the original image volume, for example, may be sampled along a curved line/plane (such as the centerline) to generate new stack of images. The reformatted 3D mask, images, or volume may then be termed reformatted mask, reformatted images or reformatted volume.

Auto CPR segmentation is a process of refining the initial 3D mask of the auto semantic segmentation process by leveraging the reformatted volume provided by the curved planar reformation process. An output of auto CPR segmentation may be termed the CPR 3D mask.

A detected disease refers to an indication of a potentially clinically relevant presence of a disease (non-limiting examples: aortic dissection, intramural hematoma, penetrating atherosclerotic ulcer, thoracic aortic aneurysm, abdominal aortic aneurysm).

Tracking is the monitoring of certain aortic features (e.g., disease, size, shape) over time using registration and measurements. For example, one may track the growth of an aneurysm over time by looking at the reformatted images in the same geometric frame and may obtain standardized measurements of the diameter.

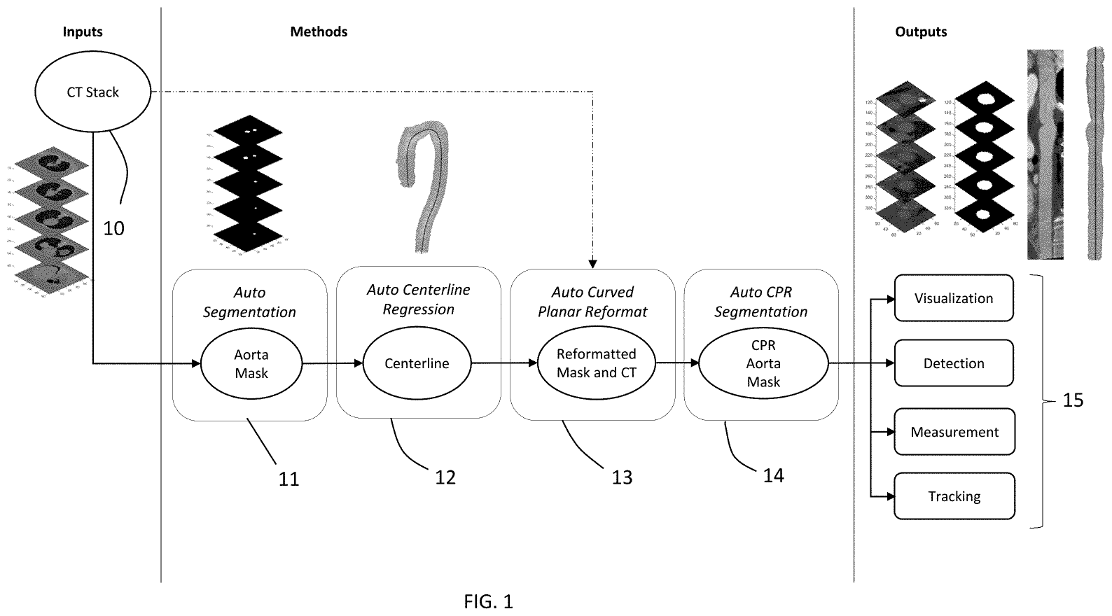

FIG. 1 depicts an example overview of various components according to aspects of the present disclosure. To summarize FIG. 1, a CT stack 10 (which may be a sequential set of CT images) may form an input to the system depicted. The CT stack may be presented to an auto segmentation component 11, which may generate an aorta mask. The aorta mask may be output to an auto centerline regression component 12, which may be used to obtain a centerline from the aorta mask. The centerline, along with the CT stack 10 (the latter either as a direct input or propagated through the previous components) and/or the aorta mask, may form inputs to an auto curved planar reformation component 13, which may output a reformatted mask and/or CT stack. These may be provided to an auto CPR segmentation component 14, which may generate a CPR aorta mask, which may be used, for example, for such purposes as visualization, detection of medical conditions, measurement, and/or tracking 15. Further details will be provided in the discussion below.

The process of FIG. 1 may involve the use of at least one neural network, and machine learning techniques, as are known in the art, may be used to train the neural network. As discussed above, an issue that may arise in training a neural network is obtaining a suitable set of training data. According to aspects of the present disclosure, the manner in which data generation curation is mitigated in order to acquire the required data samples to cover the entire space of possibility may be as follows. It is noted that the following describes one example and variations are contemplated.

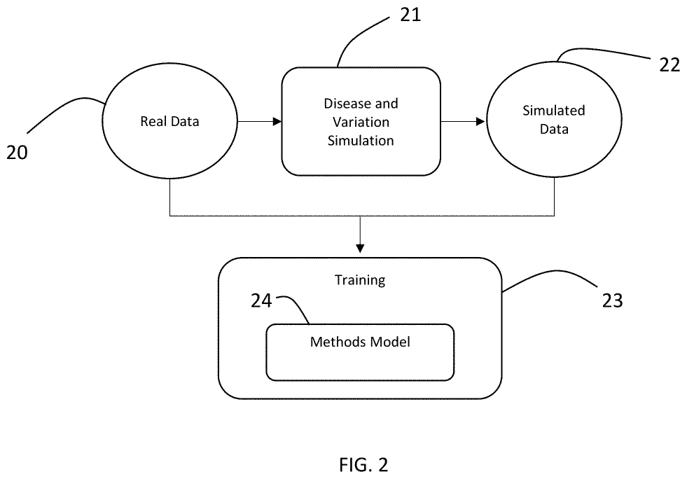

Training machine learning models that are robust in the field may require data samples that cover the entire space of possibility. This may be difficult to achieve in medical imaging, especially in the presence of pathologies. FIG. 2 reflects an example of how this may be overcome, according to aspects of the present disclosure. One may begin with existing CT data 20. To overcome the above challenge, a methodology of injecting into or modifying existing CT volumes with pathology 21 may be used to capture the expanse of possibility in pathology related to aortic disease. These diseases may include, but are not limited to, acute aortic syndrome (aortic dissection, intramural hematoma, penetrating atherosclerotic ulcer), aortic aneurysm, aortic calcification, and/or stenosis. Including both real CT images 20 and simulated diseased CT images 22 may enhance the robustness of the model 24 during training 23. This framework may be used as a basis for the training of any or all models trained in the present application; however, the invention is not thus limited.

In general, to generate 21 synthetic diseased imagery, the “disease” may be injected into the image, or the image may be modified via a set of transformations, to mimic the visual appearance of the disease.

For data simulation to train a model to regress the centerline, simulated 3D masks of aortas may be generated using simulated centerline curves. This may create aortas with a wide range of geometric properties like length, tortuosity, and diameters to be included in the training set. Disease features (such as dilations and bulges) may also be added in mask space while keeping the ground truth centerline fixed to promote robust centerline determination.

The aorta 3D mask may be generated as follows, according to aspects of the present disclosure.

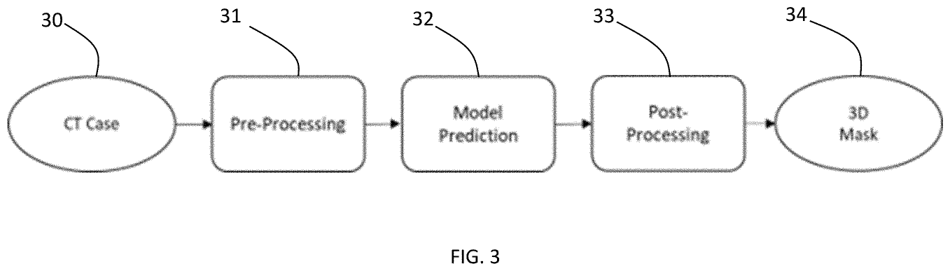

FIG. 3 depicts a high-level block diagram depicting components of an example of an auto segmentation process 11 that may be used to segment the voxels associated with thoracic and abdominal aorta in a CT volume. As an example, a machine learning model (e.g., convolutional neural network) may be used to predict the voxels associated with the aorta; however, the invention is not thus limited, and other methods of segmentation may be used. In the case of a machine learning model, training data may be generated in the manner discussed above. A 3D binary mask for the CT volume may be obtained by combining the outputs from each slice of the CT volume. Morphological operators may be applied to close any small gaps and/or remove stray objects not connected to the 3D mask.

Automatic centerline regression 12 may be performed as follows. The aorta 3D mask 34 that may be generated using auto segmentation 11 may be used to compute the aorta centerline using auto centerline regression 12. The auto centerline regression may be performed using a neural network, which may be trained using training data as discussed above. The segmented 3D mask may be automatically preprocessed 31 to normalize pose prior to the centerline computation. Then a model (e.g., convolutional neural network) may be trained using both real and synthetic data as described in FIG. 2 and may be used to predict 32 a set of voxels that correspond to the approximate region of the centerline. Post-processing 33 of the approximate region of the centerline may then be performed to achieve the final 3D centerline voxel coordinates 34. The post-processing may include, but is not limited to, thresholding, smoothing, and/or discretizing into uniform steps.

Automated measurements like the tortuosity, length, and curvature of the resulting centerline may be computed and presented as potential biomarkers for aortic disease.

Automatic curved planar reformation 13 may be performed as follows. The generated centerline may be discretized (e.g., during post-processing 33, as discussed above) into uniform steps. For example, with a desired step size of 1 mm, a 200 mm-long centerline may be represented by 201 discrete points, spaced 1 mm apart. Then, traversing the generated centerline from either of its ends, the optimal normal (slicing) plane may be determined at each of the centerline points, while considering the curvature and overlap constraints. Note that a simple normal plane at any point along the centerline may not always produce the most optimal cross-sectional slice, particularly in cases with abnormal geometries and disease. When determining the optimal normal planes, angle changes between neighboring planes along the centerline may be constrained to be smooth (curvature constraint) and neighboring planes may be constrained to have minimal overlap (overlap constraint). Determination of the optimal normal planes may be iteratively computed based on satisfying these constraints. The position and angles of the normal plans may also be learned directly via model regression (e.g., convolutional neural network) directly and/or with algorithmic methods. The data used to train the neural network may be derived from the iterative algorithm discussed above.

Instead of separate processing steps for automatic centerline regression 12 and normal plane determination (of the auto curved planar reformat 13), these may be combined in one machine learning model (e.g., convolutional neural network) to predict both the centerline and associated normal planes, and as discussed above, the data used to train the neural network may be derived from algorithmic outputs.

With the slicing planes defined in space, an image may be generated via interpolation at each of those planes and stacked together to form the reformatted mask and volume stack where the centerline is now straightened and is the central axis of the 3D volume.

This reformatted structure may be registered spatially to reformatted images at other time points to facilitate tracking of desired features.

The visualization of the reformatted stack may be presented in the standard tri-planar format of “axial, sagittal, and coronal” images in most medical image viewers. Note that due to the reformation, we lose the semantic meaning of these traditional views. Instead, since the centerline is a natural axis of rotation, rather than slicing through in the traditional sagittal or coronal directions, one may swivel about the centerline axis in the reformatted view and create images that may always have the centerline in the middle of the image. This “swivel” view may be a very visually powerful and natural view for the now-cylindrical structure as it allows the entire aorta to be analyzed and may easily be used for length, radial, and cross-sectional area measurements.

Auto CPR segmentation 14 may be performed as follows. The reformatted stack may be used as the input to a secondary, or cascaded, auto segmentation step to generate the CPR 3D mask. This cascaded approach may include a second machine learning model (e.g., convolutional neural network), trained in a similar fashion as other models described according to aspects of the present disclosure. The training data here may be labeled aorta images in the reformatted (straightened) space. This second stage output, the CPR 3D mask, may be reformatted back to the original CT volume space for visualizations or as needed for further processing or analysis.

Disease detection may be performed as follows. The aorta 3D mask may or may not be used as the landmark for the aortic disease detection methods. For example, a machine learning model (e.g., a deep learning-based image classifier) may be employed on each CT image with or without cropping to a pre-defined region of interest using the 3D mask as a landmark. The deep learning-based image classifier may be trained utilizing disease simulation as described above, although the invention is not thus limited. The trained model may be used to predict the presence of aortic disease in the CT slice. An aggregate of predictions across the CT volume may result in an overall disease prediction for the given CT volume. A non-limiting example may be the detection of aortic dissection. A single volume for 3D-based machine learning may also be used as an alternative.

An alternative approach may use as input the curved planar reformation volume and may also use as input the CPR 3D mask to infer the presence of the disease. A deep learning-based image classifier may be trained utilizing disease simulation as described in connection with FIG. 2. The trained model may be used to predict the presence of aortic disease in each slice of the curved planar reformation volume. This approach may also be applied in the alternate planes (e.g., sagittal, coronal), or as a single volume using 3D-based machine learning methods.

A method may be employed to compute diameter measurements in the curved planar reformation volume. For example, an aortic aneurysm, by definition, is a 50% increase in diameter as compared to normal (which may, for example, be a baseline measurement for a given patient or may be a typical diameter or range of diameters considered in the art as being “normal”). An automatic CPR segmentation 14 may transform the aorta into a cylindrical tube, which may provide for rapid and accurate diameter measurements in the true cross-sectional plane. It may also enable tracking across prior CT imaging volumes, which may also assist in disease classification. In particular, diameter measurements made in the origin CT imaging volume may be susceptible to error as the true cross-sectional plane is not necessarily parallel to any of the traditional axial, sagittal, or coronal planes.

Tracking may be performed as follows. Registration may be performed in both mask and CT image space by taking advantage of and aligning geometric and image intensity features. The measurements that stem from the reformation may be monitored over time for tracking purposes. Features may be grouped by location based on distance proximity in the reformatted view. Registration may be optional depending on what features are desired.

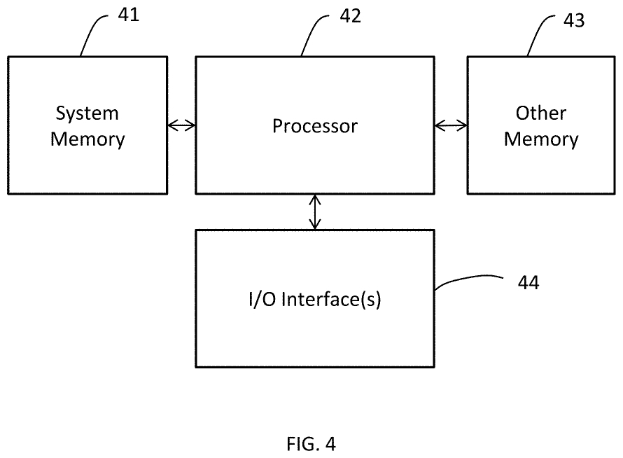

Various embodiments of aspects of the present disclosure may comprise hardware, software, and/or firmware. FIG. 4 shows an exemplary system that may be used to implement various forms and/or portions of embodiments according to various aspects of this disclosure. Such a computing system may include one or more processors 42, which may be coupled to one or more system memories 41. Such system memory 41 may include, for example, RAM, ROM, or other such machine-readable media, and system memory 41 may be used to incorporate, for example, a basic I/O system (BIOS), operating system, instructions for execution by processor 42, etc. The system may also include further memory 43, such as additional RAM, ROM, hard disk drives, or other processor-readable media. Processor 42 may also be coupled to at least one input/output (I/O) interface 44. I/O interface 44 may include one or more user interfaces, as well as readers for various types of storage media and/or connections to one or more communication networks (e.g., communication interfaces and/or modems), from which, for example, software code may be obtained or provided (e.g., by downloading or uploading).

Various aspects of the present disclosure may enable provision of useful information related to the detection and visualization of aortic disease to assist the physician. These may take any one or more of the following forms:
Indication of disease: In one aspect, indications of the presence of the detected disease may be provided.
Location of disease: In a second aspect, the locations of the detected disease may be provided.
Measurement of disease: In a third aspect, the measurements attributed to the disease of the anatomical structure of interest may be provided (non-limiting examples may include diameter of the aorta, quantification of the “amount” of calcification, and/or tortuosity of the aorta).
Tracking measurements over time: In a fourth aspect, given the first three aspects, the information may be compared over time for tracking purposes.
Reformatted mask output: In a fifth aspect, the reformatted mask of the aorta may be provided as visualization and may provide a basis upon which measurements may be made. This series of masks may be generated as traditional axial view images or as swivel view images where each image slice is taken about the centerline axis.
Reformatted volume output: In a sixth aspect, the reformatted CT images of the aorta may be provided as visualization and may provide a basis upon which measurements may be be made. This series of CT images may be generated as traditional tri-planar view images (axial, coronal, or sagittal) or as swivel view images where each image slice is taken about the centerline axis.
Centerline: In a seventh aspect, a centerline as a set of discrete 3D points may be provided for visualization and measurement.
Aorta 3D mask: In an eighth aspect, the segmentation of the aorta may be provided as an output mask as a binary representation of the voxels associated with the aorta in the original CT volume. This may be used for visualization and/or for measurements.
CPR 3D mask: In a ninth aspect, the improved segmentation of the aorta performed in the CPR domain may be provided as an output mask for visualization and/or for measurements.

Aspects of the present disclosure may find use in the automated aortic disease detection and reformatted visualization to improve radiology workflow. This may include:
Automated notification of time sensitive abnormalities for triage, such as the detection of aortic dissection.
Automated measurements and/or tracking of aortic features for rapid diagnosis and monitoring.
Improved automated visualization to save radiologists time, instead of scrolling through the original CT images and/or manually defining the reformation.
Permitting varying expertise levels where less-specialized practitioners may be able to glean the distilled information without needing to be trained in specialized software to manually define reformatted views and perform measurements.

Additionally, the information and methods presented may be used beyond clinical applications related to the aorta. These may include:
Data may be collected for future analysis and refining of the system.
Measurements and visualizations may serve as clinical research data to identify and study biomarkers.
Methods may be applied to other vascular, bone, or soft tissue structures where reformation may be useful (e.g., spine, GI tract, nerves, etc.).
Methods may be applied to other volumetric imaging modalities beyond CT (such as, but not limited to, MRI, US, PET, etc.).

It is to be understood that the above-referenced arrangements/techniques are only illustrative of the application for the principles of the present disclosure. Numerous modifications and alternative arrangements/techniques can be devised as described in the usage and extension to other applications and domains sections without departing from the spirit and scope of the present invention.

While aspects of the present disclosure have been shown in the drawings and fully described above with particularity and detail, it will be apparent to those of ordinary skill in the art that numerous modifications can be made without departing from the principles and concepts as set forth herein.

What is claimed is:

1. An automated method of processing a set of two-dimensional (2-D) radiological images representing spatial samples of a three-dimensional (3-D) representation of an anatomical feature, the method including:
segmenting the 2-D radiological images of the set to form corresponding masks corresponding to the anatomical feature, which collectively form a feature mask of the anatomical feature;
performing centerline regression on the feature mask to obtain a centerline of the anatomical feature;
performing curved planar reformation of at least one of the feature mask or the set of 2-D radiological images to obtain at least one of, respectively, a reformatted feature mask or a reformatted set of 2-D radiological images; and
performing a segmentation of the reformatted feature mask to obtain a reformation mask of the anatomical feature.

2. The method according to claim 1, wherein the anatomical feature is a blood vessel.

3. The method according to claim 2, wherein the blood vessel is an aorta.

4. The method according to claim 1, further including using at least one of the reformatted feature mask or the reformatted set of 2-D radiological images to provide a 3-D visual representation of the anatomical feature.

5. The method according to claim 1, wherein the centerline regression is performed using at least one neural network.

6. The method according to claim 5, wherein the at least one neural network is trained based on sets of images of the anatomical feature.

7. The method according to claim 1, wherein at least one of the segmenting the 2-D radiological images or segmentation of the reformatted feature mask is performed using at least one neural network.

8. The method according to claim 7, wherein the at least one neural network is trained using images of the anatomical feature in which one or more pathological features are simulated by artificially adding the one or more pathological features into normal images of the anatomical feature.

9. The method according to claim 1, wherein the curved linear reformation is performed based at least in part on vectors and associated normal planes computed algorithmically or using one or more neural networks.

10. The method according to claim 1, further including:
generating at least one quality metric of the anatomical feature; and
using the at least one quality metric to quantify or track one or more anatomical characteristics of the anatomical feature to enable diagnosis or monitoring of pathology of the anatomical feature.

11. The method according to claim 10, wherein the at least one quality metric is selected from the group consisting of: tortuosity, diameter, area, length, curvature, volume, and ratios computed from the masks, centerline, and/or reformatted 2-D images and/or 3-D representation based on the reformatted 2-D images.

12. The method according to claim 1, wherein at least portions of the performing centerline regression and the performing curved planar reformation are performed using a single neural network.

13. The method according to claim 12, wherein the neural network is trained using data derived from algorithmic outputs.

14. A non-transitory machine-readable medium containing executable code designed to implement the method according to claim 1.

15. An image processing system including:
one or more processors;
one or more input/output devices communicatively coupled to the one or more processors; and
one or more non-transitory memories communicatively coupled to the one or more processors and containing code executable by the one or more processors to implement the method according to claim 1.
